(19) United States
(12) Patent Application Publication
(10) Pub. No.: US 2024/0078070 A1
(43) Pub. Date: Mar. 7, 2024

(54) VIDEO DISTRIBUTION DEVICE, DISPLAY CONTROL DEVICE, VIDEO DISTRIBUTION METHOD, DISPLAY CONTROL METHOD, AND NON-TRANSITORY COMPUTER READABLE MEDIUM

(71) Applicant: CANON KABUSHIKI KAISHA, Tokyo (JP)

(72) Inventors: AYUMI SATO, Kanagawa (JP); AKIO YOSHIKAWA, Kanagawa (JP)

(21) Appl. No.: 18/502,981

(22) Filed: Nov. 6, 2023

Related U.S. Application Data
(63) Continuation of application No. PCT/JP2022/004495, filed on Feb. 4, 2022.

(30) Foreign Application Priority Data
May 7, 2021 (JP) 2021-079263
Jan. 19, 2022 (JP) 2022-006481

(51) Int. Cl. G06F 3/14; H04N 21/218; H04N 21/25

(52) U.S. Cl. CPC G06F 3/14; H04N 21/21805; H04N 21/25

(57) ABSTRACT

A video distribution device for distributing a video to a plurality of display control devices includes a processor; and a memory storing a program which, when executed by the processor, causes the video distribution device to acquire a plurality of videos generated by simultaneously performing capturing at different angles from a predetermined place using a plurality of imaging devices, distribute the plurality of videos as one set to the plurality of display control devices, receive, from a first display control device, display state information indicating display states of the plurality of videos included in the one set, and transmit the display state information to a second display control device in response to a request from the second control device different from the first control device, wherein the second display control device displays the one set of the plurality of videos on a screen, according to the display state information.

### CROSS-REFERENCE TO RELATED APPLICATIONS

This application is a Continuation of International Patent Application No. PCT/JP2022/004495, filed Feb. 4, 2022, which claims the benefit of Japanese Patent Application No. 2021-079263, filed May 7, 2021, and Japanese Patent Application No. 2022-006481, filed Jan. 19, 2022, which are hereby incorporated by reference herein in their entirety.

### BACKGROUND OF THE INVENTION

### Field of the Invention

The present invention relates to a video distribution device, a display control device, a video distribution method, a display control method, and a non-transitory computer readable medium.

### Background Art

In recent years, there are services which have wider communication bands, and enable simultaneous viewing of a plurality of videos. Users can freely switch positions and sizes of videos to be simultaneously displayed, and select various ways of viewing according to users' own interest. PTL 1 describes a technique with which a user selects and browses a random video from a plurality of videos to be simultaneously distributed.

However, according to the above conventional example, the user does not necessarily master a selection operation for a display method on how to display and view the plurality of videos at what timing, and cannot sufficiently enjoy an advantage of being able to display the plurality of videos.

The present invention provides a technique that enables a user to enjoy an advantage of being able to display a plurality of videos even in a case where the user has not mastered a displaying operation for the plurality of videos.

### CITATION LIST

### Patent Literature

PTL 1 Japanese Patent Laid-Open No. 2019-33362

### SUMMARY OF THE INVENTION

The present invention in its first aspect provides a video distribution device which distributes a video to a plurality of display control devices, the video distribution device comprising: a processor; and a memory storing a program which, when executed by the processor, causes the video distribution device to acquire a plurality of videos generated by simultaneously performing capturing at different angles from a predetermined place using a plurality of imaging devices, distribute the plurality of videos as one set to the plurality of display control devices, receive, from a first display control device, display state information indicating display states of the plurality of videos included in the one set, and transmit the display state information to a second display control device in response to a request from the second control device different from the first control device, wherein the second display control device displays the one set of the plurality of videos on a screen, according to the display state information.

The present invention in its second aspect provides a display control device including a processor; and a memory storing a program which, when executed by the processor, causes the display control device to receive from a video distribution device a plurality of videos as one set, the plurality of videos being generated by simultaneously performing capturing at different angles from a predetermined place using a plurality of imaging devices, perform control to display the plurality of videos on a screen, change display states of the plurality of videos included in the one set in response to a user's operation, generate, for the plurality of videos included in the one set, display state information indicating the changed display states, and transmit the generated display state information to the video distribution device.

The present invention in its third aspect provides a video distribution method for distributing a video to a plurality of display control devices, the video distribution method including acquiring a plurality of videos generated by simultaneously performing capturing at different angles from a predetermined place using a plurality of imaging devices; distributing the plurality of videos as one set to the plurality of display control devices; receiving, from a first display control device, display state information indicating display states of the plurality of videos included in the one set; and transmitting the display state information to a second display control device in response to a request from the second control device different from the first control device, wherein the second display control device displays the one set of the plurality of videos on a screen, according to the display state information.

The present invention in its fourth aspect provides a display control method including receiving from a video distribution device a plurality of videos as one set, the plurality of videos being generated by simultaneously performing capturing at different angles from a predetermined place using a plurality of imaging devices; performing control to display the plurality of videos on a screen; changing display states of the plurality of videos included in the one set in response to a user's operation; generating, for the plurality of videos included in the one set, display state information indicating the changed display states; and transmitting the generated display state information to the video distribution device.

The present invention in its fifth aspect provides a non-transitory computer readable medium that stores a program, wherein the program causes a computer to execute the above described video distribution method.

The present invention in its sixth aspect provides a non-transitory computer readable medium that stores a program, wherein the program causes a computer to execute the above described display control method.

Further features of the present invention will become apparent from the following description of exemplary embodiments with reference to the attached drawings.

### BRIEF DESCRIPTION OF THE DRAWINGS

FIG. 1 is a diagram illustrating an example of an entire configuration of a video distribution system according to embodiment 1;

FIG. 2 is a diagram illustrating a hardware configuration of a video distribution device according to embodiment 1;

FIG. 3A is a view illustrating an external appearance of a display control device according to embodiment 1;

FIG. 3B is a diagram illustrating a hardware configuration of the display control device according to embodiment 1;

FIG. 4 is a flowchart illustrating video distribution processing according to embodiment 1;

FIG. 5 is a flowchart illustrating display registration processing according to embodiment 1;

FIG. 6 is a flowchart illustrating playback processing of the display control device according to embodiment 1;

FIG. 7 is a view illustrating a display state management table according to embodiment 1; and

FIGS. 8A to 8F illustrate video display examples of the display control device according to embodiment 1.

### DESCRIPTION OF THE EMBODIMENTS

Hereinafter, a preferable embodiment of the present invention will be described with reference to the drawings. Note that numerical values and the like exemplified for more specification description are not limited thereto unless specified otherwise. Furthermore, the present invention is not limited to the following embodiment, and can be changed as appropriate without departing from the gist of the present invention. For example, each configuration of the following embodiment may be modified or changed as appropriate according to a configuration of a device to which the present invention or various conditions.

### Embodiment 1

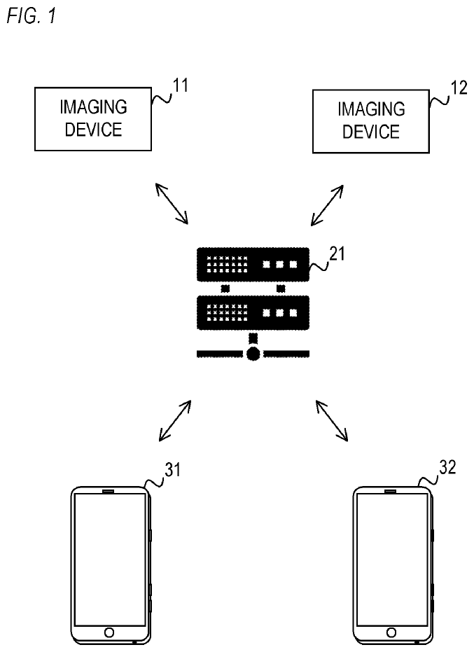

FIG. 1 is a diagram illustrating an example of an entire configuration of a video distribution system according to embodiment 1. According to the present embodiment, a video distribution device 21 distributes a plurality of videos, and each video viewing method (how to view each video) of a first display control device 31 is shared with a second display control device 32. A user of the second display control device 32 can display a plurality of videos and view the plurality of videos similar to the first display control device 31. Consequently, even in a case where the user is not familiar with how to simultaneously display and view a plurality of videos, or in a case where the user does not master an operation method, the user can enjoy an advantage that the user can simultaneously display the plurality of videos.

The video distribution system according to the present embodiment includes a imaging device 11, a imaging device 12, the video distribution device 21, the first display control device 31, and the second display control device 32. Although FIG. 1 illustrates the two imaging devices and the two display control devices as an example, a system configuration is not limited to this, and may include more imaging devices and display control devices. Videos shot by each imaging device are distributed to each display control device via the video distribution device 21. Each device may be connected via a random network, may adopt a wired or wireless communication mode, and adopt random communication standards.

The imaging devices 11 and 12 are imaging devices which shoot videos (movies), and are, for example, digital video cameras. A video shot by each imaging device is, for example, a multi-view video which can be obtained by simultaneously capturing the same place from different directions (angles). By displaying and playing back the multi-view video, a viewer can view the same scene or the same object from different viewpoints. Alternatively, a video shot by each imaging device may be, for example, a multi-direction video which can be obtained by simultaneously capturing different directions from the same place. By displaying and playing back the multi-direction video, a viewer can change a viewpoint from one place, and view the video. The video shot by each imaging device is transmitted to the video distribution device 21. Note that each imaging device may transmit a video which is being shot to the video distribution device 21 in real time, or may transmit a recorded video.

The video distribution device 21 distributes video data which includes a plurality of videos received from each imaging device as one set to the first display control device 31 and the second display control device 32. The video distribution device 21 transmits the video received from each imaging device in real time. Note that the video distribution device 21 may transmit a video recorded in advance. Furthermore, the video distribution device 21 may distribute the video distributed in real time in such a way that the video can be viewed after live streaming.

Furthermore, the video distribution device 21 also has a function of transmitting and receiving display state information of each display control device which is information related to the display state of the plurality of videos included in the one set, and sharing a viewing method for a plurality of videos between a plurality of devices. The display state information is information indicating how each frame of each of a plurality of videos is displayed and played back by each of a plurality of devices. The display state information includes at least one of display or hide of each of the plurality of videos, a display position on a screen, a display size on the screen, a display area (display angle of view), a front-rear relationship of overlap (overlapping order) with a display area of other videos, device identification information, and a playback speed. Furthermore, the display state information includes video identification information for specifying a pair of corresponding videos. Note that, in a case where, for example, one video is displayed on a full screen, the display state information may store data indicating that “the video is displayed at a size of the full screen, and the rest of videos are hidden”. Furthermore, in a case where one video is displayed on the full screen, the display state information may store data indicating that “the video is displayed at a size of the full screen, and is displayed on the frontmost side”. Furthermore, the display state information does not need to store data indicating display states of all of a plurality of videos included in one set, and may store data indicating a display state of at least one video of the plurality of videos included in the one set.

The first display control device 31 and the second display control device 32 are devices (electronic devices) which are connected with the video distribution device, and can simultaneously display the plurality of videos included in the one set received from the video distribution device 21. Examples of the devices are smartphones, tablet terminals, mobile computers, televisions, and the like. Each device can perform a changing operation for a display layout of each video (e.g., a range of each video to be displayed/a display position of each video on the screen/the display size of each video on the screen/display or hide of each video) included in the one set. Furthermore, each device may be able to perform a changing operation for a playback speed of each video. The present embodiment will describe the first display control device 31 as a device which corresponds to a “first electronic device”, and transmits the display state information to the video distribution device 21. Furthermore, the present embodiment will describe the second display control device 32 as a device which corresponds to a “second electronic device”, and refers to a viewing method of the other device for a plurality of videos. Note that one device may have both of a function of transmitting the display state information, and a function of receiving and referring to the display state information of the other devices.

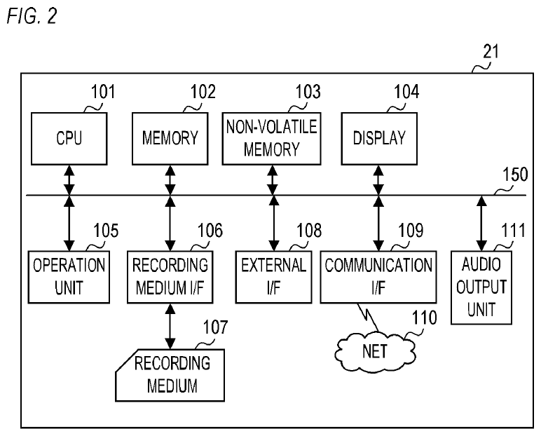

FIG. 2 is a diagram illustrating a hardware configuration of the video distribution device 21 according to the present embodiment. An internal bus 150 is connected with a CPU 101, a memory 102, a non-volatile memory 103, a display 104, an operation unit 105, a recording medium OF 106, an external OF 108, a communication OF 109, and an audio output unit 111. Each component can transmit and receive mutual data via the internal bus 150.

The CPU 101 is a control unit which controls the entire video distribution device 21, and includes at least one processor or circuit. The CPU 101 controls each unit of the video distribution device 21 using the memory 102 as a working memory according to a program stored in the non-volatile memory 103.

The memory 102 is a working memory such as a RAM which is used for temporary storage by the CPU 101.

The non-volatile memory 103 stores image data, audio data, various programs for the CPU 101 to operate, and the like. As the non-volatile memory 103, for example, a flash memory or a ROM may be used.

The display 104 is a display unit which displays, for example, a GUI screen which configures an image or a Graphical User Interface (GUI) based on control of the CPU 101. Note that components included in the video distribution device 21 itself include up to an interface which outputs video signals to be displayed by the display 104, and the display 104 may be configured as an external monitor (such as a television).

The operation unit 105 is an input device which accepts a user's operation. The operation unit 105 includes, for example, a character information input device such as a keyboard, a pointing device such as a mouse or a touch panel, a button, a dial, a joy stick, a touch sensor, a touch panel, or the like.

The recording medium OF 106 reads data from the recording medium 107, and writes data in the recording medium 107 based on control of the CPU 101.

The recording medium (recording unit) 107 records video data distributed by the video distribution device 21, and data such as the display state information of each device. As the recording medium 107, for example, a memory card, a CD, a DVD, an HDD, or the like can be used.

The external OF 108 is an interface which connects with an external device via a wired cable or wirelessly, and inputs and outputs video signals and audio signals.

The communication OF 109 is an interface which communicates with the external device, an Internet 110, and the like, and transmits and receives various items of data such as files and commands.

The audio output unit 111 outputs audios of video and music data, operation sounds, ringtones, various notification sounds, and the like. The audio output unit 111 includes an audio output terminal 111a and a speaker 111b which are connected with an earphone and the like. Furthermore, an audio may be output using a device connected by wireless communication.

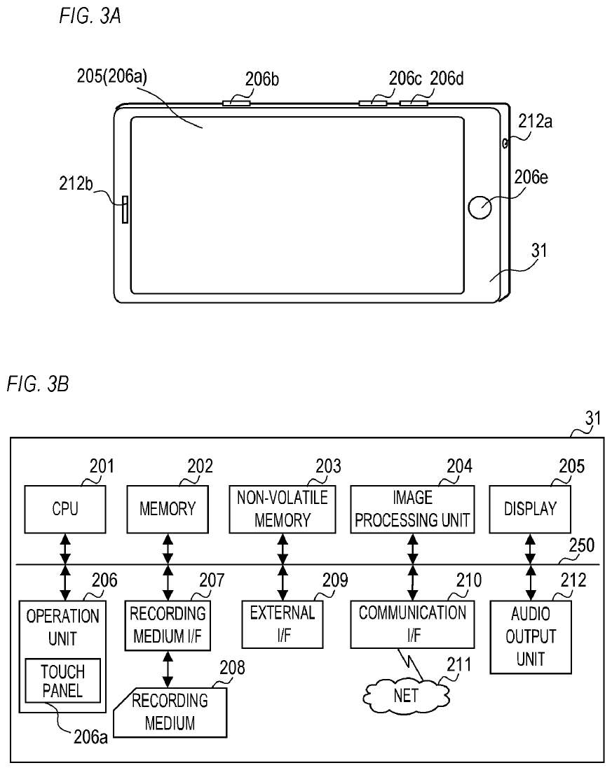

FIG. 3A is an external view of the first display control device 31. A display 205 is a display unit which displays videos received from the video distribution device 21, images, and various pieces of information. The display 205 is integrally formed with a touch panel 206a, and can detect a touch operation on a display surface of the display 205. An operation unit 206 includes the touch panel 206a, and operation units 206b, 206c, 206d, and 206e as illustrated. The operation unit 206b is a power button which accepts an operation of switching between power-on and power-off of the first display control device 31. The operation unit 206c and the operation unit 206d are volume buttons which increase and decrease a volume of an audio output from an audio output unit 222. The operation unit 206e is a home button which displays a home screen on the display 205. An audio output terminal 212a is an earphone jack, and is a terminal which outputs an audio to an earphone, an external speaker, and the like. A speaker 212b is a speaker which is built in a main body and emits an audio.

In this regard, a CPU 201 can detect following operations on the touch panel 206a or following states.

A finger or a pen which is not in touch with the touch panel 206a newly touches the touch panel 206a, that is, touch starts (hereinafter, referred to as touch-down.)

The finger or the pen is in touch with the touch panel 206a (hereinafter, referred to as touch-on) The finger or the pen is moving in touch with the touch panel 206a (hereinafter, referred to as touch-move) The finger or the pen which has been in touch with the touch panel 206a moves away from the touch panel 206a, that is, the touch ends (hereinafter, referred to as touch-up) Nothing is in touch with the touch panel 206a (hereinafter, referred to as touch-off)

When touch-down is detected, touch-on is also simultaneously detected. After touch-down, touch-on usually continues being detected as long as touch-up is not detected. When touch-move is detected, too, touch-on is simultaneously detected. Even when touch-on is detected, if a touch position has not moved, touch-move is not detected. When touch-up of all touching fingers or the pen is detected, touch-off is detected.

These operations/states and a position coordinate touched by the finger or the pen on the touch panel 206a are notified to the CPU 201 via an internal bus, and the CPU 201 determines what operation (touch operation) has been performed on the touch panel 206a based the notified information. As for touch-move, it is also possible to determine a moving direction of the finger or the pen which moves on the touch panel 206a based a change in the position coordinate per vertical component/horizontal component on the touch panel 206a. When it is detected that touch-move has moved a predetermined distance or more, it is determined that a sliding operation has been performed. An operation of quickly moving the finger for only a certain distance while keeping the finger in touch with the touch panel 206a, and then moving the finger away therefrom is referred to as flick. In other words, flick is an operation of quickly tracing the touch panel 206a while flipping the touch panel 206a with the finger. When it is detected that touch-move has moved the predetermined distance or more at a predetermined speed or more, and then touch-up is detected, it is possible to determine that flick has been performed (it is possible to determine that flick has been performed subsequently to the sliding operation). Furthermore, a touch operation of simultaneously touching a plurality of portions (e.g., two points), and bringing respective touch positions close to each other is referred to as pinch-in, and a touch operation of moving the respective touch positions away from each other is referred to as pinch-out. Pinch-out and pinch-in are collectively referred to as a pinch operation (or simply as pinch). The touch panel 206a may use any one system of a touch penal among various systems such as a resistive membrane system, a capacitive system, a surface acoustic wave system, an infrared system, an electromagnetic induction system, an image recognition system, and an optical sensor system. Although there are a system which detects a touch when a touch panel is touched, and a system which detects a touch when a finger or a pen approaches a touch panel, any system may be adopted.

FIG. 3B is a diagram illustrating a hardware configuration of the first display control device 31 according to the present embodiment. An internal bus 250 is connected with the CPU 201, a memory 202, a non-volatile memory 203, an image processing unit 204, the display 205, the operation unit 206, a recording medium I/F 207, an external OF 209, a communication I/F 210, and an audio output unit 212. Hereinafter, the configuration which is common to that of the video distribution device and the configuration described with reference to the above external view will be omitted, and the image processing unit 204 will be described.

The image processing unit 204 performs various image processing on images stored in the non-volatile memory 203 and the recording medium 208, video signals acquired via the external OF 209, images acquired via the communication OF 210, and the like based on control of the CPU 201. The image processing performed by the image processing unit 204 includes A/D conversion processing, D/A conversion processing, image data encoding processing, compression processing, decoding processing, enlargement/reduction processing (resize), noise reduction processing, color conversion processing, and the like. The image processing unit 204 may be configured as a dedicated circuit block which performs specific image processing. Furthermore, the CPU 201 may perform image processing according to a program without using the image processing unit 204 depending on an image processing type. The second display control device 32 also employs the same hardware configuration as that of the first display control device 31. Hereinafter, the configuration in FIGS. 3A and 3B will be cited as the configuration of the second display control device 32 as appropriate.

Video Distribution Processing

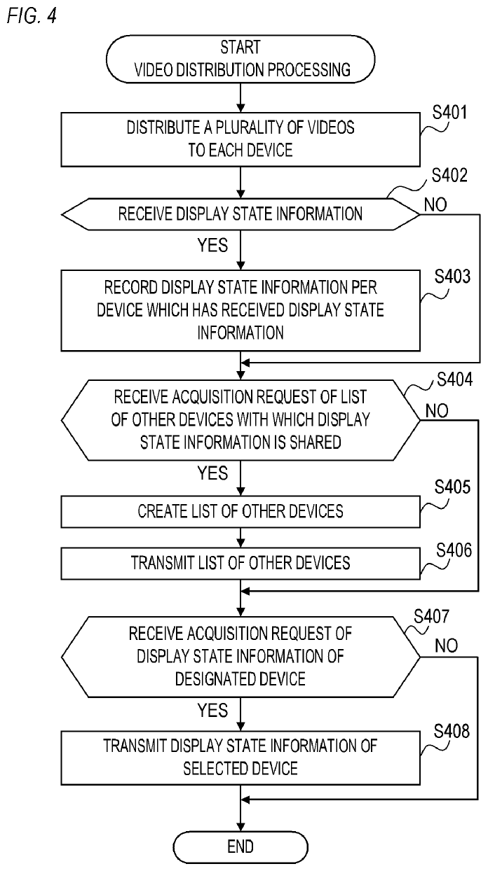

FIG. 4 is a flowchart related to the video distribution device 21 according to the present embodiment. Distribution processing for a plurality of videos and share processing for a viewing method performed by the video distribution device 21 will be described below with reference to FIG. 4.

In step S401, the CPU 101 acquires video data stored in the recording medium 107 via the recording medium OF 106, and starts distribution of video data to each device including the first display control device 31 and the second display control device 32. In the present embodiment, the CPU 101 is a video distribution unit which distributes a plurality of videos simultaneously shot by a plurality of imaging devices as one set. The plurality of videos included in the one set are associated with one common video identification information, and the plurality of videos are distributed together with the video identification information.

In step S402, the CPU 101 determines whether or not display state information which is information related to display states of predetermined frames of each of the plurality of videos included in the one set has been received from one of distribution destination devices. In the present embodiment, the CPU 101 is a display state information acquisition unit which acquires the display state information. The flow proceeds to step S403 in a case where the display state information has been received, and the flow proceeds to step S404 in a case where the display state information is not received. Note that, although processing in a case where the first display control device 31 has received the display state information will be described as an example of the present embodiment, a target whose display state information is received by the video distribution device 21 is not limited to the first display control device 31. Furthermore, the number of devices whose display state information can be received by the video distribution device 21 is not limited to one, and may be plural, and the display state information may be received from the plurality of devices.

The display state information includes at least one of display or hide of each of the plurality of videos, a display position on the screen, a display size on the screen, a display area on the screen, a front-rear relationship of overlap with a display area of other videos, device identification information (electronic device identification information), and a playback speed. The device identification information is information which has been received by the video distribution device 21 and is allocated per device to identify each device.

In step S403, the CPU 101 associates the device identification information and the display state information of each device (each electronic device) received in step S402 to record in the recording medium 107. That is, in the present embodiment, the recording medium 107 is also a recording unit which records the display state information acquired by a display state information acquisition unit (CPU 101). Here, the recording unit (recording medium 107) may associate the display state information with a frame which serves as a base for managing the plurality of videos of the one set to record. In the present embodiment, the storage unit associates the display state information with a timecode value indicating an elapsed time of a video distributed by the video distribution device 21 to store. Note that what is used for a frame serving as the base is not limited to the display state information, and, for example, the number of frames of a predetermined video of the plurality of videos may be used. Furthermore, as the frame which serves as a base, the number of frames of independent frames (I frames) which are generated by intra-frame encoding processing and does not require information of other video frames at a time of decoding may be used. Thus, by associating and recording the information for managing the plurality of videos and the display state information, it is possible to record a frame whose playback speed has been changed by each device, and information of a frame which is repeatedly viewed. Furthermore, the display state information may include data indicating preferences of a user of a device (which object in a video the user is paying attention to or what in a video the user is interested in).

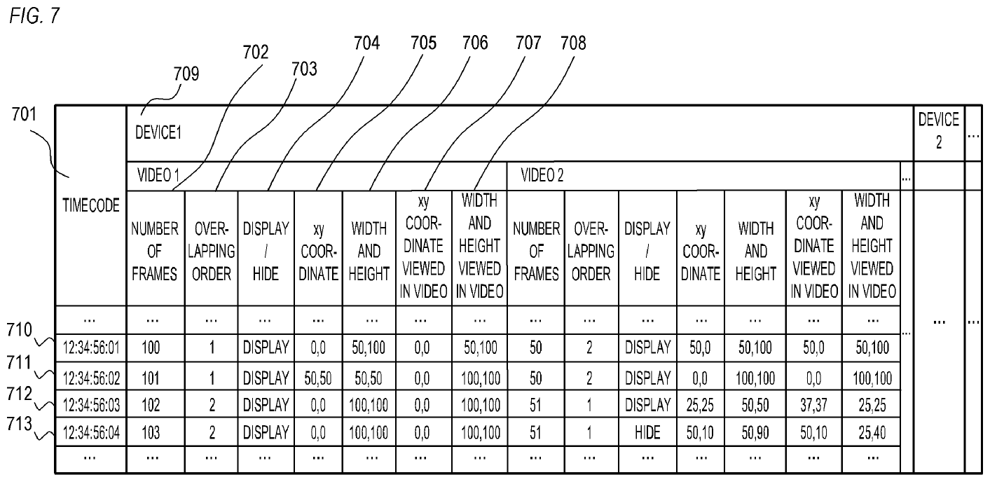

FIG. 7 illustrates a display state management table which indicates an example of the display state information recorded in the recording medium 107. The display state management table includes fields 701 to 709. In the field 701, timecodes for managing the plurality of videos are stored. Timecode values are indicated in units of “time/minute/second/frame”. In the field 702, the number of frames of each video is stored. In the field 703, an overlapping order indicating the front-rear relationship (order) of overlap of each video is stored. In this regard, the overlapping order indicates that the video is displayed closer to the front side when the value of the overlapping order is smaller. In the field 704, display/hide of each video is stored. In the field 705, a display position indicating a position on the screen of the display at which each video is displayed is stored. Here, the display position is indicated as an upper left coordinate of each video on the screen. Note that the display position may be indicated using a center coordinate or other coordinates of each video. In the field 706, a value indicating a display size of each video on the screen is stored. Here, the display size of each video is indicated as a width and a height. Note that the display size of each video may be indicated as other values, and may be indicated as, for example, an upper left coordinate and a lower right coordinate of each video. In the field 707 and the field 708, information of a display angle of view indicating which range of each video is displayed on the screen is stored. In the field 707, a position of the range of each video to be displayed on the screen is stored. Here, the position of the range of each video to be displayed on the screen is indicated as an upper left coordinate of the display area. In the field 708, a display size of each video on the screen is stored. Note that values indicated in the fields 707 and 708 may be indicated using different values similar to the fields 705 and 706. In the field 709, the device identification information which makes it possible to identify each device is stored. The device identification information is, for example, an MAC address, and, in addition, information such as account names of the Internet and a serial number of each device may be used. The video distribution device 21 records in the recording medium 107 the display state information received from each device.

In step S404, the CPU 101 determines whether or not an acquisition request of a list of other devices with which the display state information is shared has been received from the second display control device 32. In the present embodiment, the CPU 101 is an acquisition request acceptance unit which accepts an acquisition request of the display state information. The flow moves to step S405 in a case where the acquisition request has been received, and the flow moves to step S406 in a case where the acquisition request is not received.

In step S405, the CPU 101 acquires identification information of devices which have received the display state information stored in the recording medium 107, and creates the list of the devices to record in the memory 102.

In step S406, the CPU 101 acquires the list of the devices recorded in step S405 from the memory 102, and transmits the list to the second display control device 32 via the communication OF 109. That is, in the present embodiment, the CPU 101 is an information transmission unit which transmits identification information recorded in the recording unit to the second electronic device (second display control device 32). In this regard, the list to be transmitted may include the identification information of the devices which have received the display state information and, in addition, evaluation information of other users who have referred to the display state information of the plurality of videos. As the evaluation information, for example, the number of users (second electronic devices) who have referred to viewing methods of the devices may be used. Alternatively, each display state information may be selected from the list, the number of times of acceptance of the acquisition request may be counted, and the number of times of acceptance may be used as the evaluation information. Furthermore, as the evaluation information, an index indicating the degree of likeability such as the number of good reviews or scores by the users who have referred to the display state information may be used. Furthermore, the device identification information may be selected such that the list to be transmitted includes a plurality of more highly evaluated users. Consequently, the user of the second display control device 32 can more easily select the device identification information which is good to refer to.

In step S407, the CPU 101 determines whether or not the acquisition request of the display state information of the device designated from the list has been received from the second display control device 32 connected via the communication OF 109. The present embodiment will describe an example of a case where the first display control device 31 is designated, and the acquisition request includes the identification information of the first display control device 31. The flow moves to step S408 in a case where the acquisition request has been received, and the video distribution processing is finished in a case where the acquisition request is not received.

In step S408, the CPU 101 transmits the display state information of the first display control device 31 to the second display control device 32 via the communication OF 109. Thus, the information transmission unit (CPU 101) preferably transmits the display state information in response to the acquisition request. In the present embodiment, the information transmission unit transmits the display state information of the electronic device associated with the identification information included in the acquisition request to the second display control device 32. The display state information to be transmitted here may include, for example, information for reproducing the display state of the first display control device 31 for a current frame viewed by the second display control device 32. Note that the display state information may include display state information of not only a current frame, but also previous frames and subsequent frames. Consequently, the user of the second display control device 32 can view the plurality of videos similarly to the first display control device 31. Furthermore, for example, the display state information transmitted in step S408 may include information including list display which associates a preview image which shows a layout of the plurality of videos, and a time at which the layout has been changed. Consequently, the user of the second display control device 32 can learn in advance how the plurality of videos are displayed at what timing.

Registration Processing of Display Mode Information

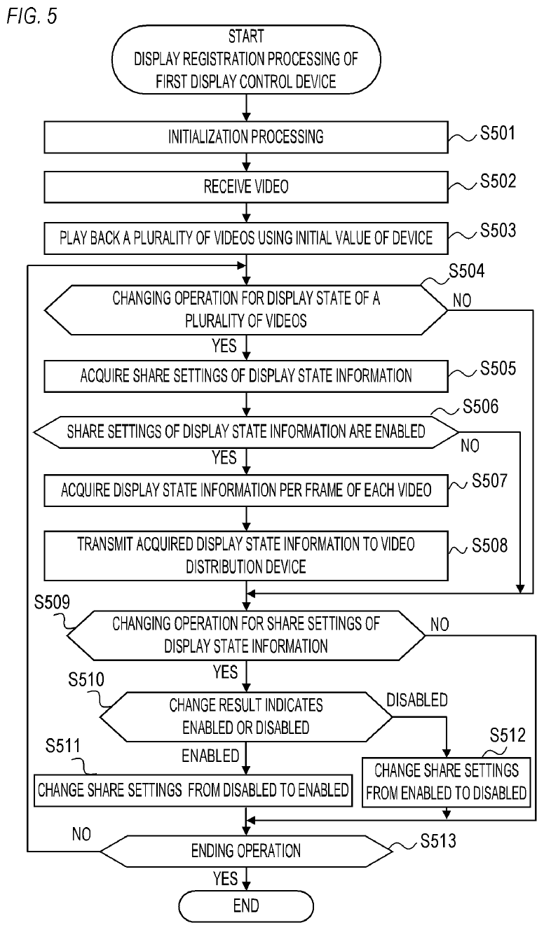

FIG. 5 is a flowchart illustrating display registration processing of transmitting to the video distribution device 21 the display state information of the first display control device 31 (first electronic device) which can simultaneously display the plurality of videos.

In step S501, the CPU 201 performs initialization processing. The initialization processing includes disabling share settings of the display state information, and initializing the display state.

In step S502, the CPU 201 receives the plurality of videos from the video distribution device 21 via the communication I/F 210. In the present embodiment, the CPU 201 is a video reception unit which receives the plurality of videos.

In step S503, the CPU 201 plays back the plurality of videos received in step S502. The plurality of videos are displayed on the display 205 (display unit) using an initial value of the first display control device 31.

The CPU 201 changes the display state of the videos in response to, for example, the user's operation (a changing operation for the display state of the videos) on the operation unit 206. In step S504, the CPU 201 determines whether or not the changing operation for the display state of the videos has been performed. In the present embodiment, the CPU 201 is a display control unit which can display the plurality of videos on the display unit, and switch display modes of the plurality of videos on the display unit. The flow proceeds to step S505 in a case where the changing operation has been performed, and proceeds to step S509 in a case where the changing operation is not performed.

In step S505, the CPU 201 acquires the share settings of the display state information.

In step S506, the CPU 201 determines whether “the share settings of the display state information” acquired in step S505 are enabled or disabled. In the present embodiment, the operation unit 206 is also a share settings acceptance unit which accepts the share settings of the display state information from the user. The flow proceeds to step S507 in a case where the share settings are “enabled”, and the flow moves to step S509 in a case where the share settings are “disabled”.

In step S507, the CPU 201 acquires the display state information of each frame for the plurality of videos acquired in step S502. The display state information includes at least one of display or hide of each of the plurality of videos, a display position on a screen, a display size on the screen, a range (display angle of view) to be displayed on the screen, a front-rear relationship of overlap (overlapping order) with other videos, device identification information, and a playback speed. Note that a frame which is an acquisition target of the display state information includes a current frame and subsequent frames which are being played back by the first display control device 31. Note that the display state information in frames before the current frame may be also acquired. In this case, a selection operation may be further set to make it possible to acquire the display state information of the previous frames according to user's selection.

In step S508, the CPU 201 transmits the display state information associated with each frame to the video distribution device 21 via the communication OF 210. In the present embodiment, the CPU 201 is also a display state information transmission unit which transmits the display state information to the video distribution device 21. Note that the display state information to be transmitted here is preferably information associated with a frame which serves as a base for managing the plurality of videos. In the present embodiment, the CPU 201 transmits the display state information associated with a timecode value to the video distribution device 21. Here, the CPU 201 sequentially transmits the display state information to the video distribution device 21. Note that the CPU 201 may transmit the display state information collectively or every predetermined frames. The predetermined frames may be defined based on an elapsed time, or may be defined based on the number of the I frames of a received video. Thus, the display state information transmission unit transmits the display state information to the video distribution device 21 in a case where the share settings acquired in step S506 are enabled. Consequently, it is possible to reflect a user's intention on whether or not to share the display state information, and then share the display state information with the other devices. Furthermore, a common value may be set to the display state information every predetermined frames.

In step S509, the CPU 201 determines whether or not the operation of changing “the share settings of the display state information” has been performed on the operation unit 206. The flow proceeds to step S510 in a case where the operation of changing the share settings has been performed, and the flow proceeds to step S511 in a case where the share settings are not changed.

In step S510, the CPU 201 determines a change result in step S509. The flow proceeds to step S511 in a case where the change result indicates “enabled”, and the flow proceeds to step S512 in a case where the change result indicates “disabled”.

In step S511, the CPU 201 changes settings of “the share settings of the display state information” from “disabled” to “enabled”, and then the flow proceeds to step S513.

In step S512, the CPU 201 changes the settings of “the share settings of the display state information” from “enabled” to “disabled”, and then the flow moves to step S513.

In step S513, the CPU 201 determines whether or not an ending operation has been performed on the operation unit 206. In a case where the ending operation has been performed, display state information registration processing is finished.

Reception Processing of Display Mode Information

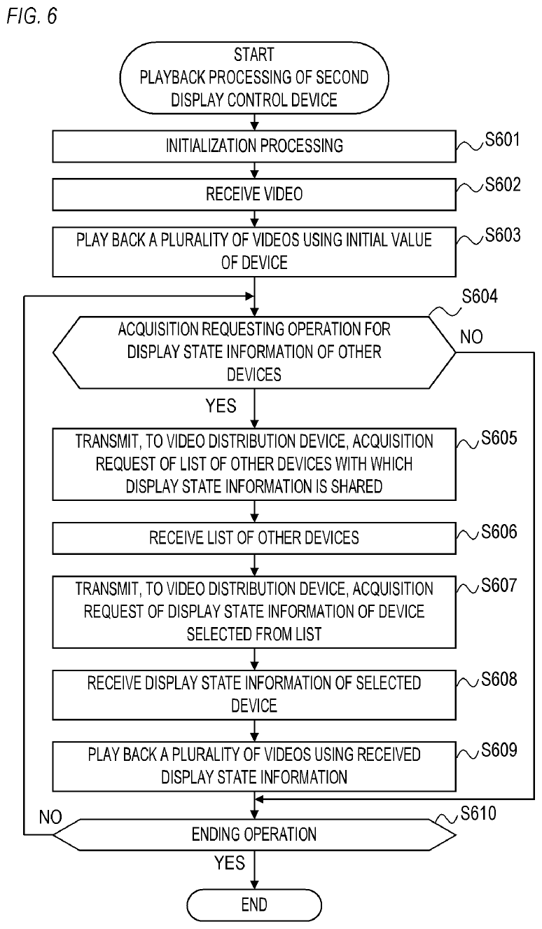

FIG. 6 is a flowchart related to playback processing of the second display control device 32.

In step S601, the CPU 201 initializes the display state of the second display control device.

In step S602, the CPU 201 receives a plurality of videos as one set from the video distribution device 21 via the communication OF 210. That is, in the present embodiment, the CPU 201 is also a video reception unit which receives the plurality of videos.

In step S603, the CPU 201 plays back the plurality of videos received in step S502. The plurality of videos included in the one set are displayed on the display 205 (display unit) using the initial value of the first display control device 31.

In step S604, the CPU 201 determines whether or not an acquiring operation for display state information of other devices has been performed on the operation unit 206. The flow moves to step S605 in a case where the acquiring operation has been performed, and the flow proceeds to step S610 in a case where the acquiring operation is not performed.

In step S605, the CPU 201 transmits an acquisition request of the list of the other devices with which the display state information is shared, to the video distribution device 21 via the communication OF 210. That is, in the present embodiment, the CPU 201 is an acquisition request transmission unit which transmits the acquisition request of the display state information to the video distribution device 21.

In S606, the CPU 201 receives the list of the other devices with which the display state information is shared, from the video distribution device 21 via the communication OF 210. That is, in the present embodiment, the CPU 201 is also an information reception unit which receives identification information of the other devices (electronic devices) whose display state information has been acquired by the video distribution device 21.

In step S607, the operation unit 206 accepts from the user a selection instruction of selecting one identification information from the pieces of identification information included in the list acquired in step S606. That is, in the present embodiment, the operation unit 206 is a selection instruction acceptance unit. In this regard, the list of the other devices received in step S606 such as a list of user names corresponding to the device identification information may be displayed on the display 205, and presented to the user. Note that the display method is not limited thereto, and, for example, a user who is shared by a large number of users, a user who is highly evaluated by other users, a user who has been previously referred to, and the like may be displayed to stand out. Consequently, the user can be referred to when the selection instruction is made in step S607. The acquisition request transmission unit (CPU 201) transmits the acquisition request of the display state information of the device obtained by performing the selection operation on the operation unit 206, to the video distribution device 21 via the communication OF 210. The acquisition request to be transmitted here includes the identification information accepted by the selection instruction acceptance unit. The present embodiment assumes a case where the first display control device 31 is selected.

In step S608, the CPU 201 receives the display state information of the first display control device 31 selected in step S607 from the video distribution device 21 via the communication OF 210. Thus, the information reception unit (CPU 201) preferably receives the display state information in response to the acquisition request, and receives from the video distribution device 21 the display state information of the electronic device associated with the identification information included in the acquisition request in the present embodiment. The display state information to be received includes whether or not to display a plurality of videos (display/hide), a display position on the screen, a display size, a range (display angle of view) to be displayed, a front-rear relationship of overlap (overlapping order), and device identification information. Note that the display state information may include a current frame and subsequent frames viewed by the second display control device 32, and, in addition, display state information of frames before the acquisition request of the display state information is accepted.

In step S609, the CPU 201 plays back the plurality of videos using the display state information received in step S608. That is, in the present embodiment, the CPU 201 is also a display control unit which can switch the display state of the plurality of videos, and causes the display unit to display the plurality of videos based on the display state information received by the information reception unit. Here, the display state of the plurality of videos in the second display control device 32 is preferably controlled such that playback is performed based on, for example, received viewing information similar to the display state of the first display control device 31. Furthermore, preferably, that the display state of the plurality of videos can be further changed in response to a user's selection operation after start of playback using the display state information of the first display control device 31. Furthermore, preferably, another device can be reselected again from the list after playback in the display state of the device which has been selected once. Consequently, the user can view the plurality of videos in display states which matches with the user's preference more. Note that, in a case where received display state information includes a frame with which the display state information is not shared, for example, the display state may be controlled to maintain a display state in a last frame.

In step S610, the CPU 201 determines whether or not the ending operation has been performed on the operation unit 206. In a case where the ending operation has been performed, playback processing is finished.

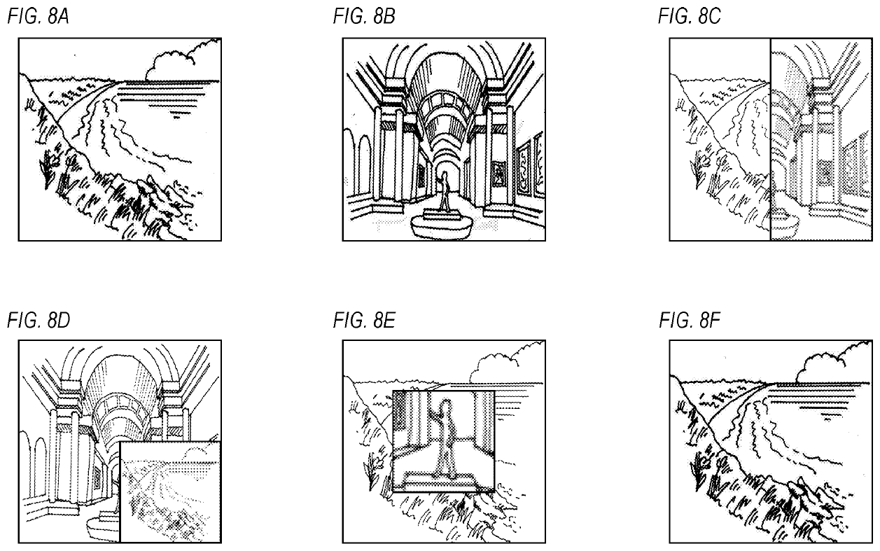

FIGS. 8A to 8F illustrate videos distributed by the video distribution device 21, and a plurality of videos displayed on the second display control device 32 according to the present embodiment. FIGS. 8A and 8B illustrate a video 1 and a video 2 distributed by the video distribution device 21. FIGS. 8C to 8F illustrate display examples of images displayed on the second display control device 32 per timecode in FIG. 7. Note that FIGS. 8C to 8F are exemplary, and a layout which can be displayed on each device is not limited to this. The following description will be provided assuming that the resolution in FIGS. 8A and 8B and the resolution of the second display 205 of the display control device 32 are each 100×100.

FIG. 8C illustrates a display example at a time when a timecode is “12:34:56:01”. The plurality of videos distributed from the video distribution device 21 are displayed on the display 205 of the second display control device 32 according to settings of a record 710 in the table in FIG. 7. As for the video 1, as can be read from values of the fields 702 to 706, an image whose number of frames is 100 is displayed in a region which is 50 in width and 100 in height from coordinates (X, Y)=(0, 0) of the display 205. Furthermore, as can be read from values of the fields 707 and 708, the region which is 50 in width and 100 in height from the coordinates (X, Y)=(0, 0) in the video 1 in the image whose number of frames is 100 is displayed. Similarly, as for the video 2, the region which is 50 in width and 100 in height from the coordinates (X, Y)=(50, 0) in the video 2 in the image whose number of frames is 50 is displayed in the region which is 50 in width and 100 in height from the coordinates (X, Y)=(50, 0) of the display 205.

FIG. 8D illustrates a display example at a time when the timecode is “12:34:56:02”. At this time, an image whose number of frames is 101 in the video 1, and an image whose number of frames is 50 in the video 2 are displayed on the display 205 according to the settings of a record 711. In this regard, as a value of the overlapping order of the field 703 is smaller, the image is displayed closer to the front side. Hence, the value of the overlapping order of each video is “1” in a case of the video 1, and is “2” in a case of the video 2, and therefore the video 1 is displayed on the front side of the video 2. Furthermore, the values of the fields 706 and 708 of the video 1 indicate 100 in width and 100 in height of the video 1 are displayed in the region which is 50 in width and 50 in height in the display 205. Hence, the video 1 is reduced and displayed on the display 205.

FIG. 8E illustrates a display example at a time when the timecode is “12:34:56:03”. At this time, an image whose number of frames is 102 in the video 1, and an image whose number of frames is 51 in the video 2 are displayed on the display 205 according to settings of a record 712. Furthermore, the value of the overlapping order of each video is “2” in a case of the video 1, and is “1” in a case of the video 2, and therefore the video 2 is displayed on the front side of the video 1. The values of the fields 706 and 708 of the video 2 indicate that 25 in width and 25 in height of the video 2 are displayed in the region which is 50 in width and 50 in height in the display 205. Hence, the video 2 is enlarged and displayed on the display 205.

FIG. 8F illustrates a display example at a time when the timecode is “12:34:56:04”. At this time, “hide” is indicated in “display/hide” in the field 704 of the video 2 according to settings of a record 713, and therefore only the video 1 is displayed on the display 205.

Furthermore, the values of the fields 702 of the video 1 and the video 2 indicate that the videos 1 and 2 are played back in different frames at different frame rates. Consequently, it is also possible to share information of, for example, a frame which is being played back by changing a playback speed.

As described above, in the present embodiment, the video distribution device distributes a plurality of videos, and the viewing method for the plurality of videos is shared between devices which can simultaneously display the plurality of videos. Consequently, users who are not familiar with the viewing method and the operating method for a plurality of videos can display and view the plurality videos similar to the other users, and enjoy an advantage that the users can display the plurality of videos.

### Modified Example

Although the display size of each video (the fields 706 and 708 in FIG. 7) is indicated as the width and the height in the present embodiment, the display size may be displayed using other values such as a combination of an upper left coordinate and a lower right coordinate in each video and a combination of a lower left coordinate and an upper right coordinate. Furthermore, the display method for the plurality of videos is not limited to a square shape, and the plurality of videos may be displayed in other shapes (such as a circular shape and an elliptical shape). Furthermore, information which is shared as the above-described display state information is merely exemplary, and may include other information. For example, information on display sizes of a plurality of videos, a motion at a time when an arrangement is switched over (switched), an animation, and the like may be also included in the display state information to perform control to display the motion at the time of switching over and the animation on the other devices likewise.

According to the present invention, when viewing a plurality of videos, the user can enjoy an advantage that the user can display the plurality of videos even in a case where the user does not master a displaying operation for the plurality of videos.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A video distribution device which distributes a video to a plurality of display control devices, the video distribution device comprising:
a processor; and
a memory storing a program which, when executed by the processor, causes the video distribution device to
acquire a plurality of videos generated by simultaneously performing capturing at different angles from a predetermined place using a plurality of imaging devices,
distribute the plurality of videos as one set to the plurality of display control devices,
receive, from a first display control device, display state information indicating display states of the plurality of videos included in the one set, and
transmit the display state information to a second display control device in response to a request from the second control device different from the first control device, wherein
the second display control device displays the one set of the plurality of videos on a screen, according to the display state information.

2. The video distribution device according to claim 1, wherein
the second display control device requests one of a plurality of display state information, and
the requested display state information is transmitted to the second display control device.

3. The video distribution device according to claim 1, wherein, when the program is executed by the processor, the program further causes the video distribution device to count a number of times of the request from the second display control device for each of a plurality of display state information.

4. The video distribution device according to claim 1, wherein the display state information indicates, for at least one of the plurality of videos included in the one set, at least one of display, hide, a display position on a screen, a display size on the screen, a display area on the screen, a relationship of overlap with a display area of another video, and a playback speed.

5. The video distribution device according to claim 4, wherein the display state information indicates the display state for each of a plurality of frames of at least one of the plurality of videos included in the one set.

6. A display control device comprising:
a processor; and
a memory storing a program which, when executed by the processor, causes the display control device to
receive from a video distribution device a plurality of videos as one set, the plurality of videos being generated by simultaneously performing capturing at different angles from a predetermined place using a plurality of imaging devices,
perform control to display the plurality of videos on a screen,
change display states of the plurality of videos included in the one set in response to a user's operation,
generate, for the plurality of videos included in the one set, display state information indicating the changed display states, and
transmit the generated display state information to the video distribution device.

7. The display control device according to claim 6, wherein
when the program is executed by the processor, the program further causes the display control device to
request the display state information indicating display states of the plurality of videos included in the one set, and
acquire the requested display state information, and
the control is performed to display the one set of the plurality of videos on the screen, according to the display state information.

8. A video distribution method for distributing a video to a plurality of display control devices, the video distribution method comprising:
acquiring a plurality of videos generated by simultaneously performing capturing at different angles from a predetermined place using a plurality of imaging devices;
distributing the plurality of videos as one set to the plurality of display control devices;
receiving, from a first display control device, display state information indicating display states of the plurality of videos included in the one set; and
transmitting the display state information to a second display control device in response to a request from the second control device different from the first control device, wherein
the second display control device displays the one set of the plurality of videos on a screen, according to the display state information.

9. A display control method comprising:
receiving from a video distribution device a plurality of videos as one set, the plurality of videos being generated by simultaneously performing capturing at different angles from a predetermined place using a plurality of imaging devices;
performing control to display the plurality of videos on a screen;
changing display states of the plurality of videos included in the one set in response to a user's operation;
generating, for the plurality of videos included in the one set, display state information indicating the changed display states; and
transmitting the generated display state information to the video distribution device.

10. A non-transitory computer readable medium that stores a program, wherein the program causes a computer to execute the video distribution method according to claim 8.

11. A non-transitory computer readable medium that stores a program, wherein the program causes a computer to execute the display control method according to claim 9.
